(19) United States
(12) Patent Application Publication
(10) Pub. No.: US 2026/0066449 A1
(43) Pub. Date: Mar. 5, 2026

(54) BATTERY ASSEMBLY INCLUDING A SELECTIVELY DECOUPLING ADHESIVE LAYER

(71) Applicant: GM GLOBAL TECHNOLOGY OPERATIONS LLC, Detroit, MI (US)

(72) Inventors: Anthony M. Coppola, Rochester Hills, MI (US); William T. Kucinski, Windsor (CA); Andrew P. Oury, Troy, MI (US); Megan E. McGovern, Ferndale, MI (US); Mohammad Hamza Kirmani, Troy, MI (US); Teresa J. Rinker, Royal Oak, MI (US)

(73) Assignee: GM GLOBAL TECHNOLOGY OPERATIONS LLC, Detroit, MI (US)

(21) Appl. No.: 18/822,986

(22) Filed: Sep. 3, 2024

(51) Int. Cl. H01M 50/375; B60L 50/64; H01M 50/204; H01M 50/271; H01M 50/293

(52) U.S. Cl. CPC H01M 50/375; B60L 50/64; H01M 50/204; H01M 50/271; H01M 50/293; H01M 2220/20

(57) ABSTRACT

A battery assembly is provided. The battery assembly includes a first battery component portion and a second battery component portion. A primary adhesive layer is coupled to the first battery component portion and is disposed between the first and second battery component portions. A selectively decoupling adhesive layer is disposed between the primary adhesive layer and the second battery component portion. The selectively decoupling adhesive layer couples the second battery component portion with the primary adhesive and the first battery component portion. The selectively decoupling adhesive layer decouples the second battery component portion from the primary adhesive layer and the first battery component portion in response to a trigger stimuli.

The disclosure generally relates to battery assemblies and methods for servicing battery assemblies.

Battery assemblies play a vital role in storing and supplying electrical energy for many applications. Examples of applications that use battery assemblies are electric vehicles, consumer products, and energy storage systems.

Battery assemblies include battery cells, which are operable for storing and supplying electrical energy. A battery cell is an electrochemical device that generates electrical energy from chemical reactions. One of the factors that determine the commercial viability of battery assemblies is its serviceability. This includes removal of various battery components from a battery assembly for recycling and/or replacement of those components with new components to extend the service life of the battery assembly.

### SUMMARY

A battery assembly in accordance with one or more embodiments is provided. The battery assembly includes a first battery component portion, a second battery component portion, and a primary adhesive layer that is coupled to the first battery component portion and is disposed between the first and second battery component portions. A selectively decoupling adhesive layer is disposed between the primary adhesive layer and the second battery component portion and couples the second battery component portion with the primary adhesive layer and the first battery component portion. The selectively decoupling adhesive layer decouples the second battery component portion from the primary adhesive layer and the first battery component portion in response to a trigger stimuli.

In some embodiments, the selectively decoupling adhesive layer includes an adhesive chosen from a vitrimer adhesive, a hot melt adhesive, a pressure sensitive adhesive, a thermoset adhesive, a thermoplastic adhesive, or a combination thereof.

In some embodiments, the selectively decoupling adhesive layer further includes ferromagnetic particles that are incorporated into the adhesive.

In some embodiments, the ferromagnetic particles are present in the adhesive in an amount of from about 1 to about 60 wt. %, based on a total weight of the selectively decoupling adhesive layer.

In some embodiments, the primary adhesive layer includes an adhesive chosen from a foam adhesive, a thermoset adhesive, a thermoplastic adhesive, or a combination thereof.

In some embodiments, the primary adhesive layer is directly coupled to the first battery component portion and the selectively decoupling adhesive layer is directly coupled to the primary adhesive layer.

In some embodiments, the selectively decoupling adhesive layer is directly coupled to the second battery component portion.

In some embodiments, the selectively decoupling adhesive layer is indirectly coupled to the first battery component portion via the primary adhesive layer.

In some embodiments, the battery assembly further includes an additional primary adhesive layer that is disposed between the selectively decoupling adhesive layer and the second battery component portion. The selectively decoupling adhesive layer is directly coupled to the additional primary adhesive layer and indirectly coupled to the second battery component portion via the additional primary adhesive layer.

In some embodiments, the first battery component portion is a battery module and the second battery component portion is a battery pack cover.

In some embodiments, the first battery component portion is a first battery cell and the second battery component portion is a second battery cell.

In some embodiments, the battery assembly further includes a pre-formed foam structure having a perimeter foam wall that surrounds an opening. The perimeter foam wall extends between the first and second battery component portions and the primary adhesive layer and the selectively decoupling adhesive layer are disposed in the opening of the pre-formed foam structure.

A method for servicing a battery assembly in accordance with one or more embodiments is provided. The method includes providing the battery assembly. The battery assembly includes a first battery component portion, a second battery component portion, and a primary adhesive layer that is coupled to the first battery component portion and disposed between the first and second battery component portions. The battery assembly further includes a selectively decoupling adhesive layer that is disposed between the primary adhesive layer and the second battery component portion and that couples the second battery component portion with the primary adhesive layer and the first battery component portion. The method further includes applying a trigger stimuli to the selectively decoupling adhesive layer such that the selectively decoupling adhesive layer responds to the trigger stimuli by decoupling the second battery component portion from the primary adhesive layer and the first battery component portion.

In some embodiments, applying includes applying the trigger stimuli that is chosen from heat, high intensity focused ultrasound, force, or a combination thereof.

In some embodiments, the trigger stimuli includes heat, and wherein applying includes applying heat to the selectively decoupling adhesive layer using a forced convection heat transfer process, a conduction heat transfer process, an induction heating process, a radiation heat transfer process, or a combination thereof.

In some embodiments, applying includes applying the high intensity focused ultrasound to the selectively decoupling adhesive layer. The high intensity focused ultrasound causes plastic wave propagation and/or heat generation through the selectively decoupling adhesive layer.

In some embodiments, the trigger stimuli includes force, and wherein applying includes applying force in an in-plane tensile mode to the selectively decoupling adhesive layer.

In some embodiments, the method further includes removing the first battery component portion and the primary adhesive layer from the battery assembly after applying the trigger stimuli.

In some embodiments, the method further includes replacing the first battery component portion and the primary adhesive layer in the battery assembly with a first replacement battery component portion and a replacement primary adhesive layer after removing. The selectively decoupling adhesive layer is coupled to the replacement primary adhesive layer by applying an additional trigger stimuli. The replacement primary adhesive layer is coupled to the first replacement battery component portion.

A device in accordance with one or more embodiments is provided. The device includes an output battery component, and a battery assembly that is configured for providing electrical energy to the output battery component. The battery assembly includes a first battery component portion, a second battery component portion, and a primary adhesive layer that is coupled to the first battery component portion and disposed between the first and second battery component portions. The battery assembly further includes a selectively decoupling adhesive layer that is disposed between the primary adhesive layer and the second battery component portion and that couples the second battery component portion with the primary adhesive layer and the first battery component portion. The selectively decoupling adhesive layer decouples the second battery component portion from the primary adhesive layer and the first battery component portion in response to a trigger stimuli.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates an exemplary device including a battery assembly in accordance with the present disclosure;

FIG. 2 schematically illustrates a portion of an exemplary battery assembly and a method for servicing the battery assembly in accordance with the present disclosure;

FIG. 3 schematically illustrates an exemplary battery assembly in accordance with the present disclosure;

FIG. 4 schematically illustrates an exemplary battery assembly in accordance with the present disclosure;

FIG. 5A schematically illustrates a side view of an exemplary battery assembly in accordance with the present disclosure;

FIG. 5B schematically illustrates a top view of the battery assembly depicted in FIG. 5A;

FIG. 6A schematically illustrates a side view of an exemplary battery assembly in accordance with the present disclosure;

FIG. 6B schematically illustrates a top view of the battery assembly depicted in FIG. 6A;

FIG. 7 schematically illustrates a portion of an exemplary battery assembly and a method for servicing the battery assembly in accordance with the present disclosure; and

FIG. 8 schematically illustrates a portion of an exemplary battery assembly and a method for servicing the battery assembly in accordance with the present disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Unless specifically stated from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, the numerical values provided herein are modified by the term “about. ”

In an exemplary embodiment, a battery assembly includes a first battery component portion and a second battery component portion. A primary adhesive layer is coupled to the first battery component portion and is disposed between the first and second battery component portions. A selectively decoupling adhesive layer is disposed between the primary adhesive layer and the second battery component portion. The selectively decoupling adhesive layer couples the second battery component portion with the primary adhesive and the first battery component portion.

When a trigger stimuli, such as, for example, heat, high intensity focused ultrasound, and/or force, is applied to the selectively decoupling adhesive layer, the selectively decoupling adhesive layer decouples the second battery component portion from the primary adhesive layer and the first battery component portion. In an exemplary embodiment, advantageously, the selectively decoupling adhesive layer allows the first battery component portion to be decoupled and removed from the second battery component portion to facilitate servicing of the battery assembly. For example, the battery assembly may be disassembled for the purposes of recycling the battery assembly. In another example, the first battery component portion may be replaced with a new or replacement first battery component portion to extend the service life of the battery assembly.

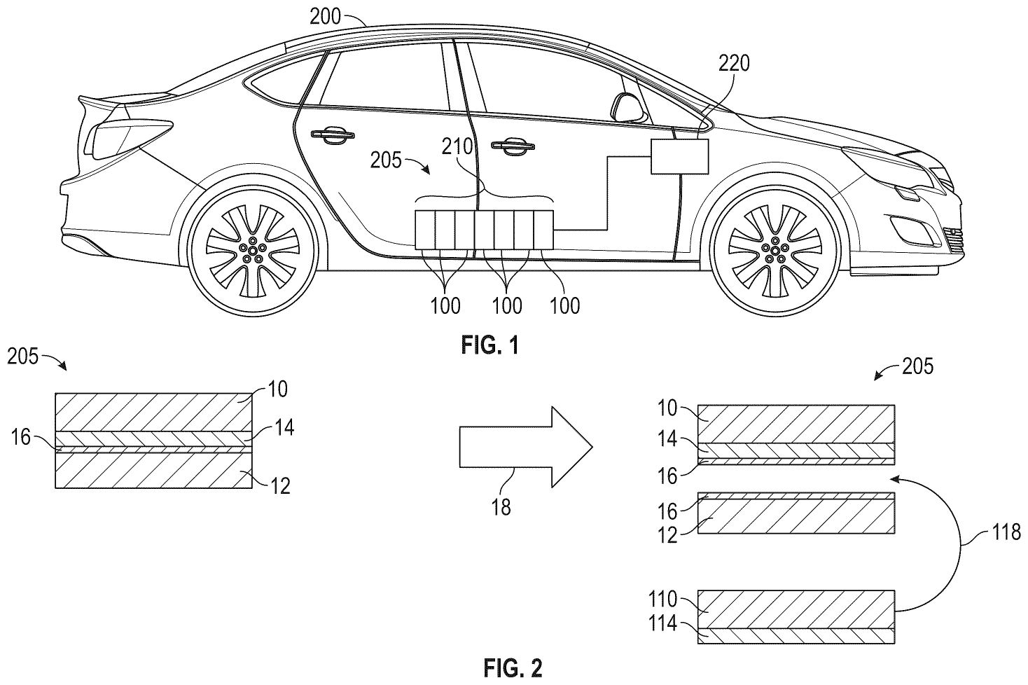

Referring now to the drawings, wherein like reference numbers refer to like features throughout the several views, FIG. 1 schematically illustrates an exemplary device 200, e.g., a battery electric vehicle (BEV), including a battery assembly 205 that includes one or more battery packs 210. The battery pack 210 includes a plurality of battery cells 100. The plurality of battery cells 100 may be connected in various combinations, for example, with a portion being connected in parallel and a portion being connected in series, to achieve goals of supplying electrical energy at a desired voltage. The battery pack 210 is illustrated as electrically connected to a motor generator unit 220 useful to provide motive force to the vehicle 200. The motor generator unit 220 may include an output component, for example, an output shaft, which is provided mechanical energy useful to provide the motive force to the vehicle 200. A number of variations to vehicle 200 are envisioned, and the disclosure is not intended to be limited to the examples provided.

FIG. 2 schematically illustrates a portion of the battery assembly 205 and a method for servicing the battery assembly 205 in accordance with an exemplary embodiment. The battery assembly 205 includes a battery component portions 10 and 12. As will be discussed in further detail below, the component battery portion 10 may be, for example, a battery cell 100, a module containing a plurality of battery cells 100, or some other component battery portion of the battery assembly 205. Likewise, the component battery portion 12 may be, for example, a battery cell 100, a module containing a plurality of battery cells 100, a battery pack cover, or some other component battery portion of the battery assembly 205.

A primary adhesive layer 14 is coupled to the battery component portion 10 and is disposed between the battery component portions 10 and 12. As illustrated, the primary adhesive layer 14 is directly coupled to the battery component portion 10. In an exemplary embodiment, the primary adhesive layer 14 includes an adhesive, such as, for example, a gap filling or foam adhesive, a thermoset adhesive, and/or a thermoplastic adhesive. Non-limiting examples of adhesives that can form the primary adhesive layer 14 include acrylic adhesive, polyurethane adhesives, epoxy adhesives, cyanoacrylate adhesives, and/or silicone adhesives. In particular examples, epoxy adhesives, silicone adhesives, and/or polyurethane adhesives that can be foamed or not may be used.

A selectively decoupling adhesive layer 16 is disposed between the primary adhesive layer and the battery component portion 12 and couples the battery component portion 12 with the primary adhesive 14 and the battery component portion 10. As illustrated, the selectively decoupling adhesive layer 16 is directly coupled to the primary adhesive layer 14 and, independently, directly coupled to the battery component portion 12. Further, the selectively decoupling adhesive layer 16 is indirectly coupled to the battery component portion 10 via the primary adhesive layer 14.

In an exemplary embodiment, the selectively decoupling adhesive layer 16 includes an adhesive chosen from a vitrimer adhesive, a hot melt adhesive, a pressure sensitive adhesive, a thermoset adhesive, a thermoplastic adhesive, or a combination thereof. In an exemplary embodiment, vitrimers are polymeric materials that can change their molecular connections at elevated temperatures dure to thermally activated bond-exchange reactions. This allows them to be initially applied as a liquid and cured to form a strong adhesive bond, but then be able to flow as a liquid when heated sufficiently.

Additionally, the selectively decoupling adhesive layer 16 may further include additives, fillers, or the like. In an exemplary embodiment, the selectively decoupling adhesive layer 16 includes ferromagnetic particles that are incorporated into the adhesive. In an exemplary embodiment, the ferromagnetic particles are present in the adhesive in an amount of about 1 to about 60 wt. %, based on a total weight of the selectively decoupling adhesive layer 16.

In an exemplary embodiment, the selectively decoupling adhesive layer 16 has a composition, formulation, or is otherwise operable to decouple the battery component portion 12 from the primary adhesive layer 14 and the battery component portion 10 in response to a trigger stimuli (indicated by single headed arrow 18). In particular, the trigger stimuli 18 is applied to the selectively decoupling adhesive layer 16 such that the selectively decoupling adhesive layer 16 responds to the trigger stimuli 18 by decoupling the battery component portion 12 from the primary adhesive layer 14 and the battery component portion 10. In an exemplary embodiment, and as will be discussed in further detail below, the trigger stimuli 18 may be heat, high intensity focused ultrasound, force, or some combination thereof. For example, heat may be applied to the selectively decoupling adhesive layer 16 to soften, liquefy, or otherwise weaken the selectively decoupling adhesive layer 16 and a force may also be applied to the soften, liquefy, or otherwise weaken selectively decoupling adhesive layer 16 to decouple the battery component portion 12 from the primary adhesive layer 14 and the battery component portion 10 for removal of the battery component portion 10.

In an exemplary embodiment, the battery assembly 205 or some portion thereof may be removed from the device 200 for serviceability, e.g., recycling, installation of replacement battery components for extended service life, or the like. As illustrated, the battery component portion 10 together with the primary adhesive layer 14 is removed from the battery assembly 205. In an exemplary embodiment, the battery component portion 10 and the primary adhesive layer 14 are replaced with a replacement battery component portion 110 together with a replacement primary adhesive layer 114. The remaining portion of the selectively decoupling adhesive layer 16 is coupled to the replacement primary adhesive layer 114 by applying an additional trigger stimuli 118. As illustrated, the replacement primary adhesive layer 114 is directly coupled to the replacement battery component portion 110.

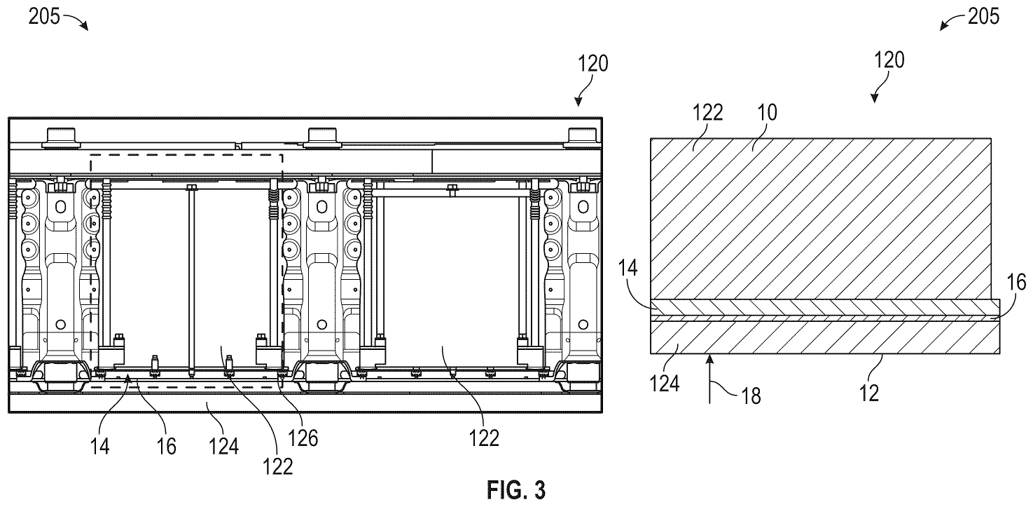

Referring also to FIG. 3, in an exemplary embodiment, the battery assembly 205 is configured as or includes a modularized pack 120 that includes a plurality of battery modules 122, where each battery module 122 contains a plurality of battery cells 100. The battery modules 122 are encased in a battery pack cover 124. In this embodiment, the battery module 122 is analogous to the battery component portion 10 and the battery pack cover 124 is analogous to the battery component portion 12. As illustrated, the primary adhesive layer 14 is directly coupled to the battery module 122 and the selectively decoupling adhesive layer 16 is disposed between and directly coupled to the primary adhesive layer 14 and the battery pack cover 124.

In an exemplary embodiment, the trigger stimuli 18 in the form of heat is applied to the selectively decoupling adhesive layer 16. In one example, heat is applied indirectly to the selectively decoupling adhesive layer 16 using a conductive heat transfer process and/or a radiation heat transfer process by applying heat along the surface of the battery pack cover 124. Alternatively, heat is applied directly or indirectly to the selectively decoupling adhesive layer 16 using a forced convection heat transfer process that blows heat through the vents 126 that are adjacent to the selectively decoupling adhesive layer 16. Alternatively, an induction heating process may be used to generate heat in the selectively decoupling adhesive layer 16, for example, in combination with the adhesive of the selectively decoupling adhesive layer 16 being loaded or otherwise containing ferromagnetic particles, which convert the inductive energy to heat.

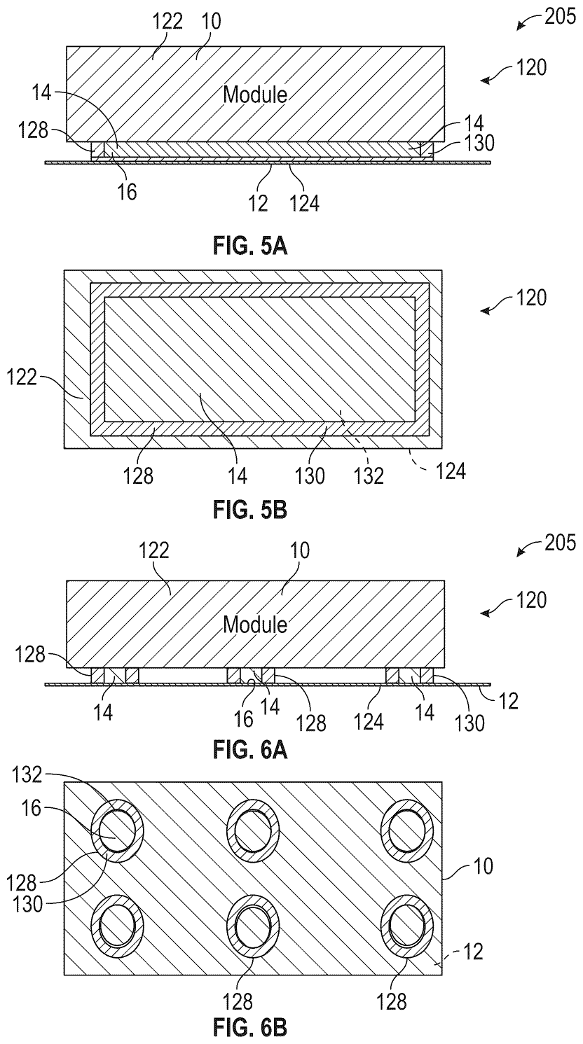

Referring also to FIGS. 5A-6B, in an exemplary embodiment, the modularized pack 120 further include a pre-formed foam structure 128 having a perimeter foam wall 130 that surrounds an opening 132. The perimeter foam wall 130 extends between the battery component portions 10 and 12 and the primary adhesive layer 14 and the selectively decoupling adhesive layer 16 are disposed in the opening 132 of the pre-formed foam structure 128. As illustrated in FIGS. 5A-5B, in an exemplary embodiment, the pre-formed foam structure 128 has a rectangular shaped perimeter foam wall 130 that surrounds a rectangular opening 132. Alternatively, more than one pre-formed foam structure 128 and/or with different shapes may be used. As illustrated in FIGS. 6A-6B, in an exemplary embodiment, a plurality of pre-formed foam structures 128, for example, with a doughnut or oval-shaped perimeter foam wall 130 may be disposed between the battery component portions 10 and 12. In an exemplary embodiment, advantageously, the pre-formed foam structure(s) 128 allow efficient usage of the primary adhesive layer 14 to fill any gaps and or spaces between the battery component portions 10 and 12.

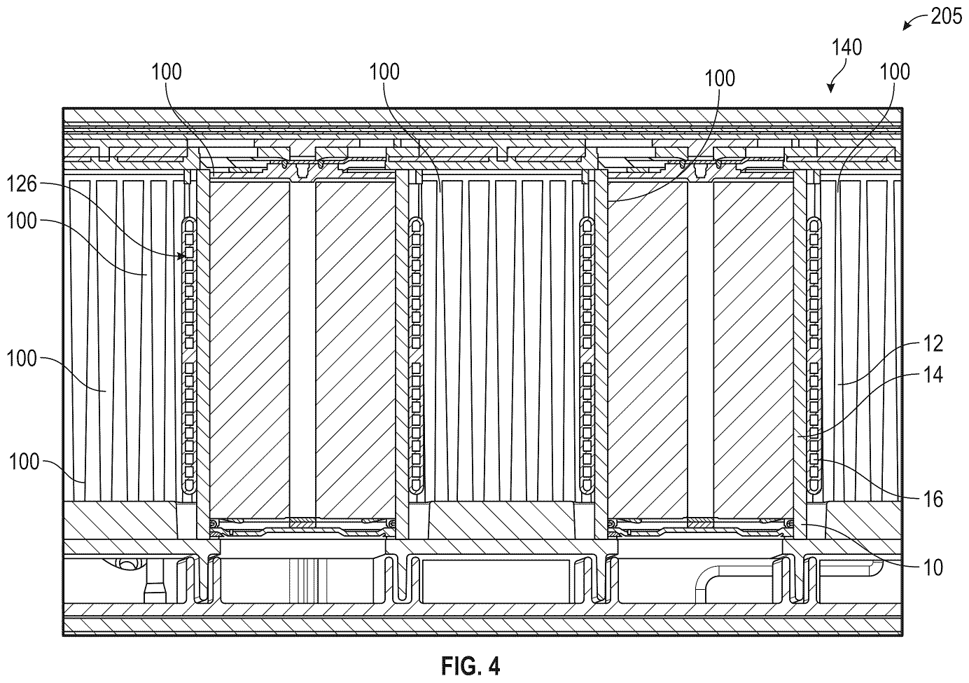

Referring to FIGS. 2 and 4, the battery assembly 205 is configured as or includes a cell pack 140 that includes a plurality of battery cells 100. In this embodiment, one battery cell 100 is analogous to the battery component portion 10 and the adjacent battery cell 100 is analogous to the battery component portion 12. In an exemplary embodiment, the selectively decoupling adhesive layer 16 further acts as a dielectric insulation layer during normal operation. In this embodiment, the trigger stimuli 18 in the form of heat is applied to the selectively decoupling adhesive layer 16, for using a forced convection heat transfer process that blows heat through the vents 126 that are adjacent to the selectively decoupling adhesive layer 16.

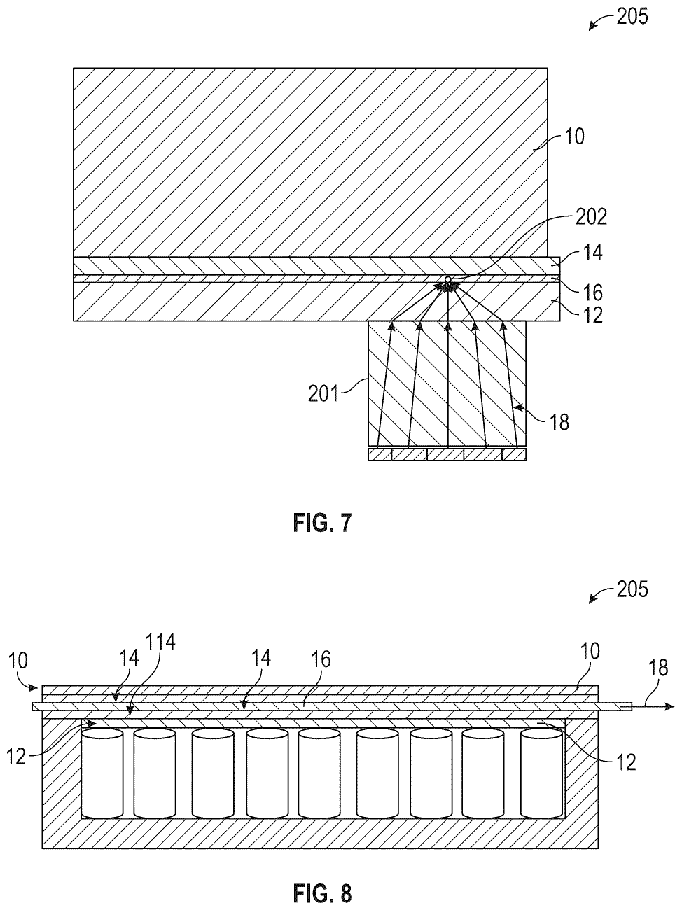

Referring to FIG. 7, in an exemplary embodiment, the trigger stimuli 18 includes a high intensity focused ultrasound that is applied to the selectively decoupling adhesive layer 16. In particular a plurality of ultrasonic waves (trigger stimuli 18) are focused at the selectively decoupling adhesive layer 16. A waveguide 201 may be used to allow for sufficient signal travel path for steering and focusing of the signals to form a focal point 202 at the selectively decoupling adhesive layer 16, thereby causing plastic wave propagation and/or heat generation through the selectively decoupling adhesive layer 16. Steering and focusing multiple elements to the focal point 202 enables ultrasound to pass through the other portions of the battery assembly 205 without damage. Decoupling may be induced from high intensity ultrasound in the form of excessive heat, vibration, or cavitation. If there is a direct path to the selectively decoupling adhesive layer 16, a single signal with a sufficiently high (e.g., destructive) amplitude can be used.

Referring to FIG. 8, in an exemplary embodiment, the battery assembly 205 further includes an additional primary adhesive layer 114 that is disposed between the selectively decoupling adhesive layer 16 and the battery component portion 12. As illustrated, the selectively decoupling adhesive layer 16 is directly coupled to the additional primary adhesive layer 114 and indirectly coupled to the battery component portion 12 via the additional primary adhesive layer 114. In an exemplary embodiment, the trigger stimuli 18 includes force that is applied in an in-plane tensile mode to the selectively decoupling adhesive layer 16, which elongates to decouple the battery component portions 10 and 12. In an exemplary embodiment, the adhesive may be a relatively high strain to failure elastomer including, for example, natural or synthetic based rubber adhesives or neoprene based adhesives. The elastomer adhesive layer could be a monolayer or have a foam core layer and elastomeric shell layers.

While the best modes for carrying out the disclosure have been described in detail, those familiar with the art to which this disclosure relates will recognize various alternative designs and embodiments for practicing the disclosure within the scope of the appended claims.

What is claimed is:

1. A battery assembly comprising:
a first battery component portion;
a second battery component portion;
a primary adhesive layer coupled to the first battery component portion and disposed between the first and second battery component portions; and
a selectively decoupling adhesive layer that is disposed between the primary adhesive layer and the second battery component portion and that couples the second battery component portion with the primary adhesive layer and the first battery component portion, and wherein the selectively decoupling adhesive layer decouples the second battery component portion from the primary adhesive layer and the first battery component portion in response to a trigger stimuli.

2. The battery assembly of claim 1, wherein the selectively decoupling adhesive layer comprises an adhesive chosen from a vitrimer adhesive, a hot melt adhesive, a pressure sensitive adhesive, a thermoset adhesive, a thermoplastic adhesive, or a combination thereof.

3. The battery assembly of claim 2, wherein the selectively decoupling adhesive layer further comprises ferromagnetic particles that are incorporated into the adhesive.

4. The battery assembly of claim 3, wherein the ferromagnetic particles are present in the adhesive in an amount of from about 1 to about 60 wt. %, based on a total weight of the selectively decoupling adhesive layer.

5. The battery assembly of claim 1, wherein the primary adhesive layer comprises an adhesive chosen from a foam adhesive, a thermoset adhesive, a thermoplastic adhesive, or a combination thereof.

6. The battery assembly of claim 1, wherein the primary adhesive layer is directly coupled to the first battery component portion and the selectively decoupling adhesive layer is directly coupled to the primary adhesive layer.

7. The battery assembly of claim 6, wherein the selectively decoupling adhesive layer is directly coupled to the second battery component portion.

8. The battery assembly of claim 6, wherein the selectively decoupling adhesive layer is indirectly coupled to the first battery component portion via the primary adhesive layer.

9. The battery assembly of claim 6, further comprising an additional primary adhesive layer that is disposed between the selectively decoupling adhesive layer and the second battery component portion, and wherein the selectively decoupling adhesive layer is directly coupled to the additional primary adhesive layer and indirectly coupled to the second battery component portion via the additional primary adhesive layer.

10. The battery assembly of claim 1, wherein the first battery component portion is a battery module and the second battery component portion is a battery pack cover.

11. The battery assembly of claim 1, wherein the first battery component portion is a first battery cell and the second battery component portion is a second battery cell.

12. The battery assembly of claim 1, further comprising a pre-formed foam structure having a perimeter foam wall that surrounds an opening, wherein the perimeter foam wall extends between the first and second battery component portions and the primary adhesive layer and the selectively decoupling adhesive layer are disposed in the opening of the pre-formed foam structure.

13. A method for servicing a battery assembly, the method comprising:
providing the battery assembly, wherein the battery assembly comprises:
a first battery component portion;
a second battery component portion;
a primary adhesive layer coupled to the first battery component portion and disposed between the first and second battery component portions; and
a selectively decoupling adhesive layer that is disposed between the primary adhesive layer and the second battery component portion and that couples the second battery component portion with the primary adhesive layer and the first battery component portion; and
applying a trigger stimuli to the selectively decoupling adhesive layer such that the selectively decoupling adhesive layer responds to the trigger stimuli by decoupling the second battery component portion from the primary adhesive layer and the first battery component portion.

14. The method of claim 13, wherein applying comprises applying the trigger stimuli that is chosen from heat, high intensity focused ultrasound, force, or a combination thereof.

15. The method of claim 14, wherein the trigger stimuli includes heat, and wherein applying comprises applying heat to the selectively decoupling adhesive layer using a forced convection heat transfer process, a conduction heat transfer process, an induction heating process, a radiation heat transfer process, or a combination thereof.

16. The method of claim 14, wherein applying comprises applying the high intensity focused ultrasound to the selectively decoupling adhesive layer, wherein the high intensity focused ultrasound causes plastic wave propagation and/or heat generation through the selectively decoupling adhesive layer.

17. The method of claim 14, wherein the trigger stimuli includes force, and wherein applying comprises applying force in an in-plane tensile mode to the selectively decoupling adhesive layer.

18. The method of claim 13, further comprising removing the first battery component portion and the primary adhesive layer from the battery assembly after applying the trigger stimuli.

19. The method of claim 18, further comprising:
replacing the first battery component portion and the primary adhesive layer in the battery assembly with a first replacement battery component portion and a replacement primary adhesive layer after removing; and
coupling the selectively decoupling adhesive layer to the replacement primary adhesive layer by applying an additional trigger stimuli, wherein the replacement primary adhesive layer is coupled to the first replacement battery component portion.

20. A device comprising:
an output battery component; and
a battery assembly configured for providing electrical energy to the output battery component, the battery assembly comprising:
a first battery component portion;
a second battery component portion;
a primary adhesive layer coupled to the first battery component portion and disposed between the first and second battery component portions; and
a selectively decoupling adhesive layer that is disposed between the primary adhesive layer and the second battery component portion and that couples the second battery component portion with the primary adhesive layer and the first battery component portion, and wherein the selectively decoupling adhesive layer decouples the second battery component portion from the primary adhesive layer and the first battery component portion in response to a trigger stimuli.
